(19) United States
(12) Patent Application Publication
(10) Pub. No.: US 2004/0174422 A1
(43) Pub. Date: Sep. 9, 2004

(54) Method of preparing a cloth for inkjet recording and a method of inkjet-printing such a cloth

(75) Inventors: Syungaku Nakamura, Fukui-shi (JP); Ayumi Yamazaki, Fukui-shi (JP)

Correspondence Address: FLYNN THIEL BOUTELL & TANIS, P.C., 2026 RAMBLING ROAD, KALAMAZOO, MI, 49008-1699, US

(73) Assignee: Seiren Co., Ltd.

(21) Appl. No.: 10/805,991

(22) Filed: Mar. 22, 2004

Related U.S. Application Data
(62) Division of application No. 09/631,574, filed on Aug. 4, 2000, now abandoned.

(30) Foreign Application Priority Data
Aug. 31, 1999 (JP) 11-246754

(51) Int. Cl. B41J 2/01

(52) U.S. Cl. 347/105

(57) ABSTRACT

Provision of an inkjet recording cloth that can be inkjet-printed using a pigment ink at a high shade depth and having excellent water and abrasion resistance without deterioration in its characteristic handling touch, a method of preparing such an inkjet recording cloth and a method of inkjet-printing the cloth. Application of an acidic solution containing a certain hydrophobic low molecular weight compound, whose melting or softening point is from 40° C. to 150° C., to a cloth forms an ink-accepting layer on the surface of the cloth before inkjet-printing it with pigment ink. Preferably, said ink-accepting layer contains a cationic resin which shows an electrical conductivity of 0.5 mS/cm to 10.0 mS/cm when dissolved in water at a concentration of 1%, and has a number average molecular weight of 1,000 to 50,000.

This is a division of Ser. No. 09/631 574, filed Aug. 4, 2000.

### BACKGROUND OF THE INVENTION

1. Field of the Invention

This invention relates to an inkjet recording or printing cloth, a method of preparing a cloth for inkjet recording or printing, and a method of recording or printing such a cloth with pigment ink using an inkjet recording or printing system.

2. Description of the Related Art

Certain technologies have already been developed for recording or printing a cloth with colorants using an inkjet recording or printing system.

As colorants for such inkjet recording or printing systems, inks containing dyes or pigments are generally used. Methods of inkjet-printing cloth with such inks have undergone various improvements to upgrade the appearance quality of the resultant printed cloth and its other quality characteristics.

In spite of these improvements, prior art methods for inkjet-printing cloth with ink containing dyes or pigments have the problem of the ink printed on the cloth bleeding out of its pattern outline (what is hereinafter referred to a “bleeding”), which constitutes a great factor adversely affecting the product appearance quality.

In addition to the bleeding problem, such conventional inkjet printing methods have other problems such as poor color fastness and brightness of the resultant printed cloth. Many technologies have been proposed to address these problems.

However, such technologies have failed to fulfill the purpose completely because, unlike paper which is physically and chemically uniform and has a relatively good affinity for dyes or pigments, cloth is a textile material composed of various substances having different chemical properties from one another and with specific orientation of its fiber structure and the presence of inter-yarn and inter-fiber pores.

Among these technologies disclosed in the prior art are a method of coating the surface or a fiber structure (cloth) with an agent for gelling a dye ink to be subsequently applied onto it for printing (JP-A-60-81379), a method of printing a cloth with a specific water repellency using a dye ink with a specific surface tension (JP-A-60-99081), a method of impregnating a cloth with a compound such as a polymer that has no affinity for a dye to be subsequently applied to the cloth for dyeing (JP-A-61-55277), a method of treating a cloth with an agent for gelling polyvinyl alcohol contained in an ink to be subsequently applied to the cloth for printing (JP-A-61-231287), a method of printing a cloth treated with a nitrogen-containing cationic substance or the like using an ink containing a water-insoluble dye (JP-A-62-45359/JP-A-2-50234/JP-A-7-119047), a method of dyeing a cloth treated with an ionic polymer or the like using an ink containing an ionic dye whose ionicity is opposite to that of the ionic polymer (JP-A-7-214765/JP-A-7-292581) and a recording medium prepared on cloth or another material as its substrate with an ink-accepting layer formed on the surface of the material, which, containing Ca or Ba ion, consists of a hygroscopic polyurethane and an acrylic polymer with a cationic group (JP-A-9-39372).

The above-mentioned prior art chiefly relates to methods of inkjet-printing cloth with dye ink.

An inkjet printing method using a dye ink, which allows a large selection of colorants available in a wide hue range for such an ink, is advantageous in that it can represent design patterns on cloth with a high color intensity and brightness.

However, this method requires a process of washing the printed cloth, which inevitably involves a process for treatment of waste water discharged from the washing process, thus presenting problems to be addressed regarding productivity and environmental pollution.

In addition, a prior art inkjet printing method, in which inkjet printing is applied to a cloth treated with a solution containing such a polymer or cationic compound as mentioned above, causes a problem of the printed cloth undergoing variations in its water resistance and/or deterioration in its handling touch depending on the type of the polymer or cationic compound.

In contrast, an inkjet printing method using a pigment ink is generally disadvantageous in that the resultant printed cloth is inferior in color intensity and brightness to its counterpart using dye ink, although it has an advantage in that the pigment in itself is highly resistant to light and weather.

Therefore, pigment ink is suitable for use as a colorant of inkjet printing to prepare an advertising cloth to be posted up outdoor as a hanging screen, banner or signboard displaying advertisements.

In addition, an inkjet printing method using a pigment ink, which generally contains a binder to fix the pigment onto the cloth at the fibrous level, has the advantage of not needing the washing of the printed cloth, unlike the case of its counterpart which uses a dye ink and requires such a washing as mentioned above.

For the aforementioned reasons, an inkjet printing method using pigment ink has recently attracted attention from the textile industry.

However, an inkjet printing method using pigment ink requires formation of an ink-accepting layer on a substrate as an inkjet recording medium for such an ink. If the substrate is paper or other similar sheet material, a conventionally practiced technology for forming such an ink-accepting layer on the surface of the material is to use silica, alumina or other similar inorganic pigment particles. If the same technology applies to cloth, the resultant printed cloth will suffer from deterioration in its characteristic handling touch, as well as poor adhesion of the ink-accepting layer to it, causing a problem with its resistance to abrasion and peeling.

In addition, the use of paper, film or other similar material, whose surface is smooth, as a recording substrate for inkjet printing with a pigment ink, allows the material to be easily printed at a high shade depth with little bleeding of the ink applied onto it. In contrast, cloth, which has irregularities on the surface of the yarn composing it, as well as pores and irregularities on its surface, is not smooth as a material for inkjet printing.

Due to such non-smoothness, cloth inkjet-printed with a pigment ink is prone to undergo variation in penetration of the pigment ink into the cloth and difficulty in uniform application of the pigment over the cloth.

The cloth inkjet-printed in such a condition eventually tends to suffer deteriorated level printing and reduced shade depth with the pigment migrating and coagulating during the drying process, making it difficult to be obtained as a printed cloth having a high shade depth and little bleeding of the pigment.

In addition, the prior art has proposed that a cloth inkjet-printed with a dye or pigment ink should be finished with a urethane resin or the like by coating, padding or other appropriate methods to increase its water and abrasion resistance. However, such finishing presents problems such as a deterioration in the cloth's handling touch and need of an additional process of applying the resin to the cloth.

### SUMMARY OF THE INVENTION

The present invention was made under the above-described technical background in order to solve these problems.

Accordingly, it is an object of the present invention to provide an inkjet recording cloth that can be inkjet-printed using a pigment ink at a high shade depth and has an excellent water and abrasion resistance without deterioration in its characteristic handling touch, a method of preparing such an inkjet recording cloth and a method of inkjet-printing the cloth.

As a result of our diligent efforts to solve the problems of the prior art, the inventors discovered that these problems could be solved by application of an acidic solution containing a certain low molecular weight compound to a cloth for formation of an ink-accepting layer on the surface of the cloth before inkjet-printing it with a pigment ink. Based on this discovery, the inventors accomplished the present invention.

Specifically, to solve the above-mentioned problems involved in the prior art, the present invention consists in:

(1) an inkjet recording cloth, comprising an acidic ink-accepting layer containing a hydrophobic low molecular weight compound, whose melting or softening point is from 40° C. to 150° C., formed on the surface of the cloth;

(2) an inkjet recording cloth as specified in (1) above, wherein said hydrophobic low molecular weight compound consists of at least one type of compound selected from low molecular weight alkylenes, fatty acid amides and polyhydric alcohol fatty acid esters;

(3) an inkjet recording cloth as specified in (1) or (2) above, wherein said ink-accepting layer additionally contains a cationic resin, which shows an electrical conductivity of 0.5 mS/cm to 10.0 mS/cm when dissolved in water at a concentration of 1%, and has a number average molecular weight of 1,000 to 50,000;

(4) an inkjet recording cloth as specified in (1), (2) or (3) above, wherein said ink-accepting layer ranges in pH from 2.0 to 6.0;

(5) a method of preparing a cloth for inkjet recording, in which the cloth is coated with an acidic aqueous solution containing a hydrophobic low molecular weight compound, whose melting or softening point is from 40° C. to 150° C., and dried to form an ink-accepting layer on its surface;

(6) a method of preparing a cloth for inkjet recording as specified in (5) above, wherein said hydrophobic low molecular weight compound consists of at least one type of compound selected from low molecular weight alkylenes, fatty acid amides and polyhydric alcohol fatty acid esters;

(7) a method of preparing a cloth for inkjet recording as specified in (5) or (6), wherein said acid aqueous solution ranges in pH from 2.0 to 6.0;

(8) a method of preparing a cloth for inkjet recording as specified in (5), (6) or (7), wherein said acid aqueous solution additionally contains a cationic resin, which shows an electrical conductivity of 0.5 mS/cm to 10.0 mS/cm when dissolved in water at a concentration of 1%, and has a number average molecular weight of 1,000 to 50,000;

(9) a method of printing an inkjet recording cloth specified in (1), (2), (3) or (4) above with a pigment ink using an inkjet recording system; and

(10) an inkjet printing method as specified in (9), wherein the inkjet printed cloth is thermally treated at a temperature now lower than the melting or softening point of the hydrophobic low molecular weight compound applied to it to form a film on its surface.

### DETAILED DESCRIPTION OF THE PREFERRED EMBODIMENTS

The present invention is to provide an inkjet recording cloth that can be printed with a pigment as a colorant using an inkjet printing system at a high shade depth and has an excellent water and abrasion resistance without deterioration in its characteristic handling touch.

According to the present invention, an acidic aqueous solution containing a certain low molecular weight compound is applied to the surface of a cloth to be inkjet-printed so as to provide it with improved water and abrasion resistance.

For the purpose of the present invention, the cloth treated with such a solution is dried for formation of an ink-accepting layer on its surface to make it a recording cloth suitable for use in inkjet printing.

The cloth thus obtained according to the present invention can be printed with a pigment using an inkjet printing system at a high shade depth with excellent water and abrasion resistance without deterioration in its characteristic handling touch.

Useful low molecular weight compounds contained in an acid aqueous solution (also hereinafter referred to as an “ink acceptor solution” where appropriate) to be applied to a cloth to be inkjet-printed according to the present invention range in their melting or softening points from 40° C. to 150° C., preferably 50° C. to 140° C.

According to the present invention, application of a pigment ink to a cloth prepared by the present invention should be achieved so that the pigment is uniformly dispersed over the ink-accepting layer formed on the surface of the cloth with its particle size remaining small and its surface area large to allow the printed cloth to be obtained with improvements both in the shade depth and ink bleeding prevention.

Failure to apply pigment ink to a cloth with uniform dispersion of the pigment over the ink accepting layer on the surface of the cloth causes the molecules of the pigment to coagulate with the resultant enlargement of its particle size, resulting in the printed cloth deteriorating both in the shade depth and ink bleeding prevention.

Useful hydrophobic low molecular weight compounds of the present invention can comprise compounds with a number average molecular weight of 10,000 or below, preferably 5,000 or below, more preferably 100 to 2,000.

Similar compounds with a number average molecular weight of more than 10,000 are not useful for the present invention in terms of their high melting or softening points or poor emulsifiability/dispersibility in formation of an adequate ink-accepting layer on a cloth to be inkjet-printed according to the present invention.

The application of a hydrophobic low molecular weight compound to a cloth to be inkjet-printed with a pigment ink according to the present invention allows an ink-accepting layer to be formed on the surface of the cloth, making it smooth and uniformly hydrophobic, so that the pigment ink can be uniformly inkjet-printed on the cloth surface.

The ink-accepting layer thus formed on the surface of a cloth according to the present invention also acts to keep the pigment ink's water component, which dispersing the pigment, from penetrating into the interior of the cloth during inkjet printing of the ink onto it.

Also, during the process of drying the cloth thus ink-jet printed, the ink-accepting layer of the present invention can prevent the ink from migrating through it, allowing the pigment particles to be applied uniformly over the surface of the cloth.

Such action of the ink-accepting layer formed on the surface of a cloth according to the present invention as mentioned above enables the cloth to be inkjet-printed with a pigment ink at a high shade depth with little bleeding of the ink.

According to the present invention, the cloth thus inkjet-printed with a pigment ink is then subjected to thermal treatment at a temperature not lower than the melting or softening point of the low molecular weight compound so as to melt or soften it so that it can thereafter solidify itself, covering the inkjet-printed area to fix the pigment firmly, thereby providing the printed cloth with excellent water and abrasion resistance.

Useful low molecular weight compounds of the present invention range in their melting or softening point from 40° C. to 150° C. Similar compounds with a melting or softening point of less than 40° C. are not useful for the present invention in terms of their low melting or softening points and present a problem of stability in forming an ink-accepting layer on a cloth and/or stability in storage of the cloth with an ink-accepting layer thus formed on its surface. On the other hand, no similar compound with a melting or softening point of more than 150° C. is useful for the present invention, requiring the resultant printed cloth to be subjected to thermal treatment at a high temperature of more than 150° C. to melt or soften the compound, which may result in the occurrence of problems with the cloth such as its yellowing and degradation, as well as deterioration in its characteristic handling touch.

The above-mentioned action of a compound applied to a cloth to be inkjet-printed according to the present invention can be achieved only if the compound is a hydrophobic low molecular weight compound having a melting or softening point in a certain range.

Pigment ink for use by an inkjet printing system according to the present invention contains an ionic polymer to increase the dispersion of the pigment in the ink by electrical repulsion and has its pH controlled to be in the neutral to weakly alkaline range for its stabilization. Accordingly, a useful aqueous solution containing a hydrophobic low molecular weight compound of the present invention is acidic, which allows the pigment of the ink applied to a cloth treated with the solution to be fixed more firmly onto the ink-accepting layer formed on the surface of the cloth.

The useful hydrophobic low molecular weight compound of the present invention can comprise at least one type of compound adequately selected according to the type of fiber composing a cloth to be inkjet-printed, the condition under an ink-acceptor solution is applied to the cloth, the type of pigment ink to be applied to the cloth, and the required physical properties of the resultant printed cloth from certain hydrophobic low molecular weight compounds including, but not limited to, low molecular weight alkylenes such as low molecular weight polyethylene, paraffin wax and polyethylene wax, petrochemical synthetic waxes such as micro-crystalline wax, petrolatum and Fischer-Tropsch wax, vegetable waxes such as carnauba wax, candelilla wax, rice wax and Japan tallow wax, mineral waxes such as montan wax, ozokerite and ceresin, fatty acid amides such as ethylene bis-stearin amide, stearic acid amide, oleic acid amide and methyl stearin amide, higher alcohols such as ethoxyl cetyl alcohol and ethoxyl stearyl alcohol, glycerol fatty acid esters such as glycerol oleate and glycerol stearate, polyhydric alcohol fatty acid esters such as propylene glycol stearate, ethylene glycol and other glycol fatty acid esters, and derivatives of 12-hydroxystearic acid such as 12-hydroxystearate, calcium 12-hydroxystearate and 12-hydroxystearate acid amide.

The low molecular weight alkylenes according to the present invention refer to compounds with a number average molecular weight of 10,000 or below, preferably 5,000 or below, more preferably 100 to 2,000. The higher alcohols that are useful in the present invention refer to alcohols, the number of carbons of which is 12 or more, preferably 16 or more.

Among the above-mentioned hydrophobic low molecular weight compounds, low molecular weight alkylenes, fatty acid amides and polyhydric alcohol fatty acid esters are preferred for the present invention in consideration of their stronger tendency to adhere to and cover the cloth to which they are to be applied.

According to the present invention, the use of two or more of these low molecular weight compounds mixed together is more preferred because their emulsification and dispersion can occur more easily than otherwise.

A preferred amount of a certain low molecular weight compound of the present invention that is to be applied to a cloth to be inkjet-printed is 0.5 to 20% by weight relative to the cloth. A certain low molecular weight compound of the present invention applied to a cloth to be inkjet-printed in an amount of less than 0.5% by weight relative to the cloth is insufficient to form an adequate ink-accepting layer on the surface of the cloth to prevent the ink applied to it from penetrating through it, also failing to provide it not only with an improved shade depth, but also with satisfactory water and abrasion resistance after its thermal treatment.

Conversely, if a certain low molecular weight compound of the present invention is applied to a cloth to be inkjet-printed in an amount of more than 20% by weight relative to the cloth, the resultant printed cloth not only shows no such great improvement in water and abrasion resistance as expected, but also may have the problem of ink bleeding and/or poor level printing.

Accordingly, a certain low molecular weight compound of the present invention should be preferably applied to a cloth to be inkjet-printed in such a way as to form an ink-accepting layer on the cloth with a thickness of 0.25 to 20 μm, thereby providing it with the effects of preventing the ink applied to it from penetrating through it and improving its resultant shade depth, water and abrasion resistance.

The useful ink-accepting layer formed on a cloth to be inkjet-printed according to the present invention is acidic to provide it with the effect of breaking down the dispersion of the ink applied to it and fixing the pigment onto it.

Accordingly, an aqueous solution containing a certain hydrophobic low molecular weight compound as an ink-acceptor of the present invention should be preferably pH-controlled at 2.0 to 6.0, more preferably 2.5 to 5.0 before being applied to a cloth to be inkjet-printed with pigment ink.

The use of an ink-acceptor solution of the present invention adjusted to a pH value of less than 2.0 may result in the occurrence of trouble such as corrosion of the machine used for application of the solution to a cloth and degradation of the cloth. On the other hand, the application of a similar ink-acceptor solution controlled at or above pH 6 to a cloth may result in formation of an ink-accepting layer on the cloth with a reduced effect of breaking down the dispersion of the pigment ink applied to it.

The useful pH controllers for adjustment of an ink-acceptor solution of the present invention to a preferred range comprise phosphoric acid, boric acid, silicic acid, acetic acid, carbonic acid, citric acid, tartaric acid, maleic acid, phthalic acid and malic acid.

Whether the ink-accepting layer formed on a cloth according to the present invention is acidic or not can be judged according to the following procedure; take a 5.0±0.1 g sample from the cloth, place the sample in 50 ml of distilled water put in a 200 ml flask with a ground glass stopper and shake the flask thoroughly for extraction to measure the pH of the extract with a pH meter.

The useful ink-acceptor solution of the present invention that is to be applied to a cloth to be inkjet-printed with a pigment ink can contain one or more types of cationic resin to provide the ink-accepting layer resultantly formed on the cloth with the effect of fixing the pigment onto it by using a difference of its ionicity from that of the ink.

Cationic resins that are useful in achieving the above-mentioned purpose of the present invention preferably comprise at least one type of cationic resin which shows an electrical conductivity of 0.5 mS/cm to 10.0 mS/cm when dissolved in water at a concentration of 1%, and has a number average molecular weight of 1,000 to 50,000.

According to the present invention, a cationic resin with a cross-linking group at the terminal of its molecule or with a molecular weight of several tens of thousands may be useful in providing the resultant printed cloth with further improved water resistance.

The use of a cationic resin with an electrical conductivity of less than 0.5 mS/cm in an ink-acceptor solution to be applied to a cloth according to the present invention results in insufficiency of an ionic component on the cloth that can bond to the molecules of the pigment applied to it, causing an increase in the quantity of unfixed pigment molecules on it with a consequent reduction in its water resistance.

In addition, this insufficiency of an ionic component on a cloth to be inkjet-printed with pigment ink causes the pigment molecules to coagulate to particles small in size, resulting in reduced color brightness and shade depth of the printed cloth.

Conversely, if the electrical conductivity of a cationic resin contained in an ink-acceptor solution to be applied to a cloth according to the present invention is more than 10.0 mS/cm, the cloth will be supplied with an abundance of an ionic component that can bond to the molecules of the pigment applied to it, allowing its shade depth to be increased, but with unreacted resin molecules left on its surface, resulting in a reduction in its water resistance, as well as a deterioration in its hue.

Among such cationic resins useful for the present invention are polymers and oligomers formed from one or more of amines such as ethyleneamine, butylamine, ethylenediamine, propylenediamine, triethylenediamine, diethylenetriamine, hexamethylenetriamine, allylamine, diallylamine and epichlorohydrine dimethylamine, quaternary ammonium salts such as lauryl trimethylammonium chloride and benzyl tributylammonium chloride, and dicyans such as dicyanamide, dicyandiamide and dicyandiamide diethylenetriamine.

Conventionally, the cationic charge of a cationic resin has been used as an indicator for its performance. In this case, however, the cationic charge of the cationic resin is measured by judging the equivalence point of its colloidal titration, which is liable to cause errors in the measurement, not causing its cationic charge thus obtained to necessarily correlate with its pigment ink fixing capability.

However, the electrical conductivity of the cationic resin and its molecular weight as adopted as an indicator for its performance according to the present invention show a marked correlation with its pigment ink fixing capability, allowing it, if adequately selected as specified herein, to act for the above-mentioned purpose of the present invention in an extremely effective manner.

The procedure for measuring the electrical conductivity of a cationic resin according to the present invention is as follows:

Dissolve the resin in deionized water at a concentration of 1% and measure the resultant aqueous solution using an electrical conductivity meter CM-20S (manufactured by Toa Denpa Kogyo Co., Ltd.).

A useful ink-acceptor solution containing the cationic resin of the present invention that is to be applied to a cloth to be inkjet-printed can preferably contain a metal with a valence of two or more to provide the resultant ink-accepting layer formed on the cloth with the further effect of coagulating the molecules of the pigment applied to it while maintaining its fine dispersion.

The metal with a valence of two referred to in the present invention includes Cu, Zn, Ca, Sn and Ba, while metal with a valence of 3 that is useful for a similar purpose comprises Al and Fe.

The above-mentioned acidic ink-acceptor solution containing a certain hydrophobic low molecular weight compound with or without a cationic resin according to the present invention can contain a binder, cross-linking agent, viscosity controller, penetrant and other auxiliary agents if necessary to help achieve the objects of the present invention and/or further improve the properties and characteristics of the resultant printed cloth.

These agents useful in the present invention can comprise publicly known agents, preferably ones that can be vaporized from the resultant inkjet-printed cloth or insolubilized on it after its thermal treatment, not adversely affecting its water resistance.

Useful methods of applying an ink-acceptor solution of the present invention to a cloth to be inkjet-printed include a method whereby the solution is applied directly to the cloth and a method whereby the solution is formed into a film with which to laminate the cloth.

Among the methods for applying an ink-acceptor solution of the present invention directly to a cloth to be inkjet-printed are, for instance, gravure, coating and mangle padding.

In addition, an inkjet system is also useful in applying an ink-acceptor solution of the present invention to a cloth to be inkjet-printed.

The cloth useful for inkjet printing according to the present invention can comprise any and all types of fabrics such as woven, knitted and non-woven. Among these fabrics, woven and knitted ones are preferable for the present invention.

The useful cloth for inkjet printing according to the present invention can be composed of a material including a natural fiber such as cotton and hemp, regenerated fiber such as rayon, semi-synthetic fiber such as acetate and triacetate, synthetic fiber such as polyester, nylon, acrylic, polypropylene and polyethylene and blends of one or more thereof. Among them, a fiber that is not subject to acid embrittlement should be preferably used to compose a cloth useful in the present invention because the cloth needs to be resistant to an ink-accepting layer formed on it according to the present invention, the pH of which is on an acidic side.

The ink-jet systems that are useful in applying pigment ink to a cloth treated according to the present invention include the charge modulating type, micro-dotting type, electrification jet controlling type, ink mist type and other continuous type systems, and stemme type (two component chamber type), pulse jet type (one component chamber type), bubble jet type, electrostatic suction type and other on-demand type systems.

According to the present invention, the cloth treated with an ink-acceptor solution of the present invention and printed with a pigment ink using an inkjet printing system useful in the present invention is to be subjected to thermal treatment to fix the pigment onto the fiber of the cloth.

Such thermal treatment of the cloth inkjet-printed according to the present invention can be achieved using either dry or wet heat, preferably at a temperature not lower than the melting or softening point of the hydrophobic low molecular weight compound applied to the cloth before the inkjet printing according to the present invention.

This thermal treatment of the present invention allows said hydrophobic low molecular weight compound to melt or soften to cover the ink-jet printed surface of the cloth, thereby improving its water resistance.

The present invention will be understood more readily by reference to the following examples of its embodiments. However, these examples are intended to illustrate the present invention and are not to be construed to limit the scope of the present invention.

The cloths inkjet-printed according to the present invention and conventional procedures for purposes of comparison were evaluated for the following items as described below.

Shade Depth

The shade depth of each inkjet-printed cloth was determined by measuring its black ink solid-printed portion with a reflective shade depth meter (Macbeth-made RD918 model). If the cloth is measured with a higher value, it can be regarded as higher and better in its shade depth.

Water Resistance

The water resistance of each inkjet-printed cloth was determined by immersing a specimen, cut from the cloth, in water at room temperature with a white cloth attached to the specimen for 24 hours, and judging the level of stain on the white cloth (as a result of pigment migration from the specimen) according to the following three-grade (∘Δx) rating scale:

∘: No stain

Δ: Moderate stain

x: Excessive stain

Bleeding

For determination of its bleeding, each inkjet-printed with a full-color image was visually judged for sharpness of its image pattern outline according to the following three-grade ((∘Δx) rating scale:

∘: Sharp pattern outline

Δ: Slightly blunt pattern outline

x: Appreciably blunt pattern outline

Abrasion Resistance

The abrasion resistance of each inkjet-printed cloth was determined by subjecting the cloth to rubbing test JIS L-0849 and judging it according to the following three-grade ((∘Δx) rating scale:

∘: Good abrasion resistance

Δ: Slightly poor abrasion resistances

x: Poor abrasion resistance

Peel Adhesion

The peel adhesion of each inkjet-printed cloth was determined by attaching an adhesive tape to its printed surface and peeling off the tape to judge the peeling of the color according to the following three-grade (∘Δx) rating scale:

∘: No peeling

Δ: Slight peeling

x: Appreciable peeling

Handling Touch

The handling touch of each inkjet-printed cloth was determined by judging it according to the following three-grade ((∘Δx) rating scale:

∘: Good handling touch

Δ: Slightly poor handling touch

x: Poor handling touch

### EXAMPLE 1

(1) Cloth: Polyester 100% plain weave fabric

(2) Ink-acceptor solution: (pH 4.2)

| Lipo-oil NT-15 | 3 | parts |
|---|---|---|
| (Nicca Chemical Co., Ltd.-prepared compound based on | | |
| glycerol fatty acid ester and low molecular weight | | |
| alkylene with a melting point of 60° C.) | | |
| Neofix E-117 | 10 | parts |
| (Nicca Chemical Co., Ltd.-prepared compound based on | | |
| polyethylenepolyamine resin with an electrical | | |
| conductivity of 2.2 mS/cm and a molecular weight of 2,500) | | |
| U-Ramin T-566 | 1 | part |
| (Mitsui Chemicals, Inc.-prepared cross-linking agent | | |
| based on melamine) | | |
| Isopropyl alcohol | 1 | part |
| (for use as a penetrant) | | |
| Acetic acid | 2 | parts |
| Water | 83 | parts |

Ink-acceptor solution (2) was applied to a cloth (1) by mangle padding with a pickup ratio of 80% and the cloth was dried at 100° C. for one minute to prepare it for inkjet printing.

The inkjet printing cloth thus prepared was printed with pigment ink using an inkjet printing system.

The pigment ink was prepared according to the following ink recipe.

(3) Ink recipe

Pigment

C.I. Pigment Yellow 151 (P.Y. 151)

C.I. Pigment Red 122 (P.R. 122)

C.I. Pigment Blue 15:3 (P.B. 15:3)

C.I. Pigment Blue Black 7 (P. Bl. 7)

Additives

Surface-active agent, preservative agent, binder, wetting agent, anti-foaming agent

Solvent

Water

The inkjet printing system was set for inkjet printing under the following condition.

(4) Inkjet printing condition

Nozzle diameter: 100 μm

Driving voltage: 100V

Frequency: 5 KHz

Resolution: 360 dpi

The inkjet-printed cloth was subjected to thermal treatment at 150° C. for two minutes and measured for such evaluation as described herein above, the results of which are shown in Table 1.

### EXAMPLE 2

(1) Cloth: Polyester 100% plain stitch knit fabric

(2) Ink-acceptor solution: (pH 3.8)

| Lipo-oil NT-6 | 5 | parts |
|---|---|---|
| (Nicca Chemical Co., Ltd.-prepared compound based on | | |
| polyhydric alcohol fatty acid ester with a melting point | | |
| of 70° C.) | | |
| Acetic acid | 2 | parts |
| Isopropyl alcohol | 1 | part |
| (for use as a penetrant) | | |
| Water | 91 | parts |

Ink-acceptor solution (2) was applied to a cloth (1) by mangle padding with a pickup ratio of 80% and the cloth was dried at 100° C. for one minute to prepare it for inkjet printing.

The inkjet printing cloth thus prepared was printed with pigment ink using an inkjet printing system under the same ink recipe and inkjet printing condition as in the case of Example 1.

The inkjet-printed cloth was subjected to thermal treatment at 150° C. for two minutes and measured for such evaluation as described herein above, the results of which are shown in Table 1.

### EXAMPLE 3

(1) Cloth: Polyester 100% plain weave fabric (same as used in Example 1)

(2) Ink-acceptor solution: (pH 4.5)

| EMUSTAR-0413 | 3 | parts |
|---|---|---|
| (Nippon Seiro Co., Ltd.-prepared compound based on | | |
| vegetable waxes with a melting point of 80° C.) | | |
| Neofix E-117 | 10 | parts |
| (Nicca Chemical Co., Ltd.-prepared compound based on | | |
| polyethylenepolyamine resin with an electrical | | |
| conductivity of 2.2 mS/cm and a molecular weight of 2,500) | | |
| Patelacol IJ-150 | 30 | parts |
| (Dainippon Ink & Chemicals Inc.-prepared compound | | |
| based on water-soluble urethane resin) | | |
| Isopropyl alcohol | 1 | part |
| (for use as a penetrant) | | |
| Water | 56 | parts |

Ink-acceptor solution (2) was applied to cloth (1) by gravure coating with an add-on of 40 g/m² and the cloth was dried at 100° C. for one minute to prepare it for inkjet printing.

The inkjet printing cloth thus prepared was printed with a pigment ink using an inkjet printing system under the same ink recipe and inkjet printing condition as in the case of Example 1.

The inkjet-printed cloth was subjected to thermal treatment at 150° C. for two minutes and measured for evaluation as described herein above, the results of which are shown in Table 1.

### EXAMPLE 4

(1) Cloth: Polyester 100% plain weave fabric (same as used in Example 1)

(2) Ink-acceptor solution: (pH 5.0)

| Poligen WE1 | 3 | parts |
|---|---|---|
| (BASF Corporation-prepared compound based on low | | |
| molecular weight alkylene with a melting point of 120° C.) | | |
| Neofix E-117 | 10 | parts |
| (Nicca Chemical Co., Ltd.-prepared compound based on | | |
| polyethylenepolyamine resin with an electrical | | |
| conductivity of 2.2 mS/cm and a molecular weight of 2,500) | | |
| U-Ramin T-566 | 1 | part |
| (Mitsui Chemicals, Inc.-prepared cross-linking based | | |
| on melamine) | | |
| Acetic acid | 1 | part |
| Isopropyl alcohol | 1 | part |
| (for use as a penetrant) | | |
| Water | 84 | parts |

Ink-acceptor solution (2) was applied to a cloth (1) by mangle padding with a pickup ratio of 80% and the cloth was dried at 100° C. for one minute to prepare it for inkjet printing.

The inkjet printing cloth thus prepared was printed with pigment ink using an inkjet printing system under the same ink recipe and inkjet printing condition as in the case of Example 1.

The inkjet-printed cloth was subjected to thermal treatment at 150° C. for two minutes and measured for evaluation as described herein above, the results of which are shown in Table 1.

### COMPARATIVE EXAMPLE 1

(1) Cloth: Polyester 100% plain weave fabric (same as used in Example 1)

(2) Ink-acceptor solution: (pH 4.2)

| Neofix E-117 | 10 | parts |
|---|---|---|
| (Nicca Chemical Co., Ltd.-prepared compound based on | | |
| polyethylenepolyamine resin with an electrical | | |
| conductivity of 2.2 mS/cm and a molecular weight of 2,500) | | |
| U-Ramin T-566 | 1 | part |
| (Mitsui Chemicals, Inc.-prepared cross-linking agent | | |
| based on melamine) | | |
| Isopropyl alcohol | 1 | part |
| (for use as a penetrant) | | |
| Acetic acid | 2 | parts |
| Water | 86 | parts |

Ink-acceptor solution (2) was applied to a cloth (1) by mangle padding with a pickup ratio of 80% and the cloth was dried at 100° C. for one minute to prepare it for inkjet printing.

The inkjet printing cloth thus prepared was printed with pigment ink using an inkjet printing system under the same ink recipe and inkjet printing condition as in the case of Example 1.

The inkjet-printed cloth was subjected to thermal treatment at 150° C. for two minutes and measured for such evaluation as described herein above, the results of which are shown in Table 1.

### COMPARATIVE EXAMPLE 2

(1) Cloth: Polyester 100% plain weave fabric (same as used in Example 1)

(2) Ink-acceptor solution: (ph 7.6)

| Lipo-oil NT-15 | 5 | parts |
|---|---|---|
| (Nicca Chemical Co., Ltd.-prepared compound based on | | |
| glycerol fatty acid ester and low molecular weight | | |
| alkylene with a melting point of 60° C.) | | |
| Neofix SS | 10 | parts |
| (Nicca Chemical Co., Ltd.-prepared compound based on | | |
| polyethylenepolyamine resin with an electrical | | |
| conductivity of 1.1 mS/cm and a molecular weight of 1,500) | | |
| Isopropyl alcohol | 1 | part |
| (for use as a penetrant) | | |
| U-Ramin T-566 | 1 | part |
| (Mitsui Chemicals, Inc.-prepared cross-linking agent | | |
| based on melamine) | | |
| Water | 83 | parts |

Ink-acceptor solution (2) was applied to a cloth (1) by mangle padding with a pickup ratio of 80% and the cloth was dried at 100° C. for one minute to prepare it for inkjet printing.

The inkjet printing cloth thus prepared was printed with pigment ink using an inkjet printing system under the same ink recipe and inkjet printing condition as in the case of Example 1.

The inkjet-printed cloth was subjected to thermal treatment at 150° C. for two minutes and measured for such evaluation as described herein above, the results of which are shown in Table 1.

### COMPARATIVE EXAMPLE 3

(1) Cloth: Polyester 100% plain weave fabric (same as used in Example 1)

(2) Ink-acceptor solution: (pH 3.8)

| CLA-530 (Kyoeisha Chemical Co., Ltd.-prepared | | |
|---|---|---|
| compound based on silica hydrate) | 10 | parts |
| Neofix E-117 | 10 | parts |
| (Nicca Chemical Co., Ltd.-prepared compound based on | | |
| polyethylenepolyamine resin with an electrical | | |
| conductivity of 2.2 mS/cm and a molecular weight of 2,500) | | |
| Neostecker CB (Nicca Chemical Co., Ltd.-prepared | | |
| compound based on acrylic resin) | 10 | parts |
| Acetic acid | 2 | parts |
| Water | 60 | parts |

Ink-acceptor solution (2) was applied to a cloth (1) by mangle padding with a pickup ratio of 80% and the cloth was dried at 100° C. for one minute to prepare it for inkjet printing.

The inkjet printing cloth thus prepared was printed with pigment ink using an inkjet printing system under the same ink recipe and inkjet printing condition as in the case of Example 1.

The inkjet-printed cloth was subjected to thermal treatment at 150° C. for two minutes and measured for evaluation as described herein above, the results of which are shown in Table 1.

### COMPARATIVE EXAMPLE 4

(1) Cloth: Polyester 100% plain weave fabric (same as used in Example 1)

(2) Ink-acceptor solution: (pH 3.8)

| Markead 3002 | 5 | parts |
|---|---|---|
| (Arakawa Chemical Industries Ltd.-prepared | | |
| compound based on maleic resin with a melting point | | |
| of 170° C.) | 10 | parts |
| Neofix E-117 | 10 | parts |
| (Nicca Chemical Co., Ltd.-prepared compound | | |
| based on polyethylenepolyamine resin with an | | |
| electrical conductivity of 2.2 mS/cm and a | | |
| molecular weight of 2,500) | | |
| Isopropyl alcohol | 1 | part |
| (for use as a penetrant) | | |
| Acetic acid | 2 | parts |
| Water | 82 | parts |

Ink-acceptor solution (2) was applied to a cloth (1) by mangle padding with a pickup ratio of 80% and the cloth was dried at 100° C. for one minute to prepare it for inkjet printing.

The inkjet printing cloth thus prepared was printed with a pigment ink using an inkjet printing system under the same ink recipe and inkjet printing condition as in the case of Example 1.

The inkjet-printed cloth was subjected to thermal treatment at 150° C. for two minutes and measured for evaluation as described herein above, the results of which are shown in Table 1.

### COMPARATIVE EXAMPLE 5

(1) Cloth: Polyester 100% plain weave fabric (same as used in Example 1)

(2) Ink-acceptor solution: (pH 7)

| Neostecker PB-3 | 80 | parts |
|---|---|---|
| (Nicca Chemical Co., Ltd.-prepared compound based on | | |
| acrylic polymer) | | |
| Water | 20 | parts |

Ink-acceptor solution (2) was applied to a cloth (1) by coating and the cloth was dried at 100° C. for one minute to prepare it for inkjet printing.

The inkjet printing cloth thus prepared was printed with a pigment ink using an inkjet printing system under the same ink recipe and inkjet printing condition as in the case of Example 1.

The inkjet-printed cloth was subjected to thermal treatment at 150° C. for two minutes and measured for evaluation as described herein above, the results of which are shown in Table 1.

What is claimed is:

1. An inkjet printing method comprising the steps of coating a cloth with an acid aqueous solution containing a hydrophobic low molecular weight compound whose melting or softening point is from 40-150°, drying the coated cloth to form an ink-accepting layer on its surface, printing on the ink-accepting layer with a pigment ink utilizing an inkjet recording system and thermally treating the inkjet printed cloth at a temperature not lower than the melting or softening point of the hydrophobic low molecular weight compound to form a film on the surface of the cloth.

2. The inkjet printing method of claim 1, wherein the hydrophobic low molecular weight compound is at least one compound selected from the group consisting of low molecular weight alkylenes, fatty acid amides and polyhydric alcohol fatty acid esters.

3. The inkjet printing method of claim 1, wherein the acid aqueous solution has a pH of from 2.0-6.0.

4. The inkjet printing method of claim 1, wherein the acid aqueous solution additionally contains a cationic resin having an electrical conductivity of 0.5-10 mS/cm when dissolved in water at a concentration of 1% and a number average molecular weight of 1,000-50,000.
